(19) United States
(12) Patent Application Publication
(10) Pub. No.: US 2013/0257727 A1
(43) Pub. Date: Oct. 3, 2013

(54) INPUT DEVICE AND METHOD FOR SIMULATING INPUT USING INPUT DEVICE

(71) Applicant: KUAN-HUNG SHEN, Shindian (TW)

(72) Inventor: KUAN-HUNG SHEN, Shindian (TW)

(73) Assignee: FIH (HONG KONG) LIMITED, Kowloon (HK)

(21) Appl. No.: 13/541,773

(22) Filed: Jul. 5, 2012

(30) Foreign Application Priority Data
Mar. 27, 2012 (TW) 101110521

(51) Int. Cl. G06F 3/01; G06F 3/033

(52) U.S. Cl. 345/161; 345/156

(57) ABSTRACT

An input device samples movement data in relation to movements of the input device and stores the movement data and associations between the movement data and the movements of the input device in a sample database. The input device determines a simulating input function of the input device according to a present movement of the input device according to associations between the movement data and movements of the input device. The input device transmits information of the present movement to a target platform. The target platform transforms the received information of the present movement to a corresponding operation command, and outputs the corresponding operation on a screen of the target platform by executing the corresponding operation command.

### BACKGROUND

1. Technical Field

Embodiments of the present disclosure generally relate to input devices, and particularly to an input device and a method for simulating input using the input device.

2. Description of Related Art

Many input devices need an auxiliary device to receive operation data input from the input devices. Without the auxiliary device, the operation of the input device cannot output to a target platform (such as a computer). For example, a stylus needs a handwriting pad, and a joystick needs a pedestal. However, the auxiliary devices are a waste of money and not convenient to carry.

### BRIEF DESCRIPTION OF THE DRAWINGS

FIG. 1 is a schematic diagram of one embodiment of an input device.

FIG. 2 is a block diagram of one embodiment of function modules of a simulating unit of the input device in FIG. 1.

FIG. 3 is a flowchart of one embodiment of a method for simulating input using the input device in FIG. 1.

FIG. 4A-4C are schematic diagrams of embodiments of simulating input using the input device in FIG. 1.

### DETAILED DESCRIPTION

The application is illustrated by way of examples and not by way of limitation in the figures of the accompanying drawings in which like references indicate similar elements. It should be noted that references to “an” or “one” embodiment in this disclosure are not necessarily to the same embodiment, and such references mean “at least one”.

In general, the word “module”, as used herein, refers to logic embodied in hardware or firmware, or to a collection of software instructions, written in a programming language, such as, Java, C, or assembly. One or more software instructions in the modules may be embedded in hardware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

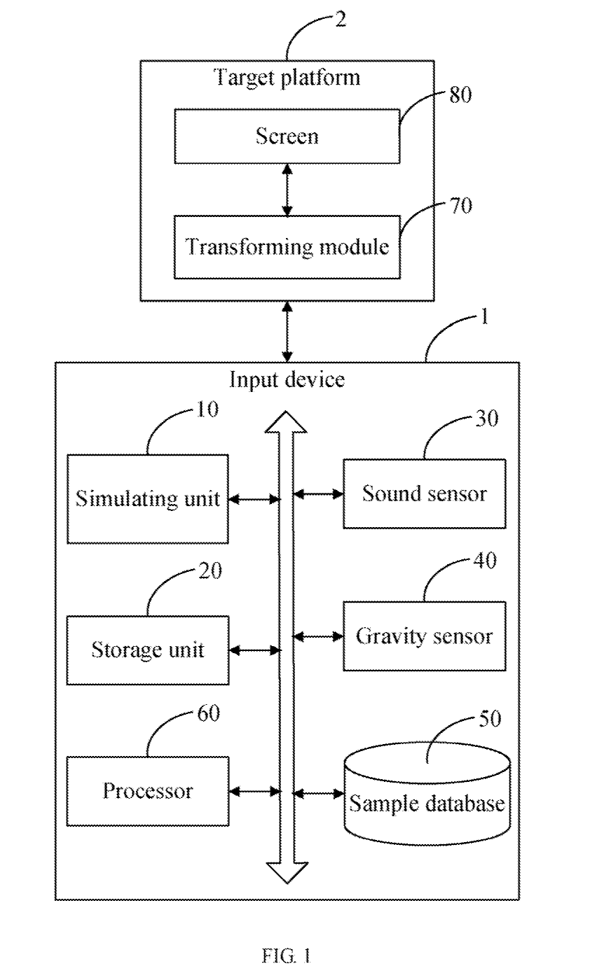

FIG. 1 is a schematic diagram of one embodiment of an input device 1. In the embodiment, the input device 1 includes a simulating unit 10, a storage unit 20, a sound sensor 30, a gravity sensor 40, a sample database 50, and a processor 60. The input device 1 may be a stylus or a mobile phone, for example. The input device 1 is wirelessly connected to a target platform 2, which includes a transforming module 70 and a screen 80. The target platform 2 may be a computing device (such as a computer) or a display device, for example.

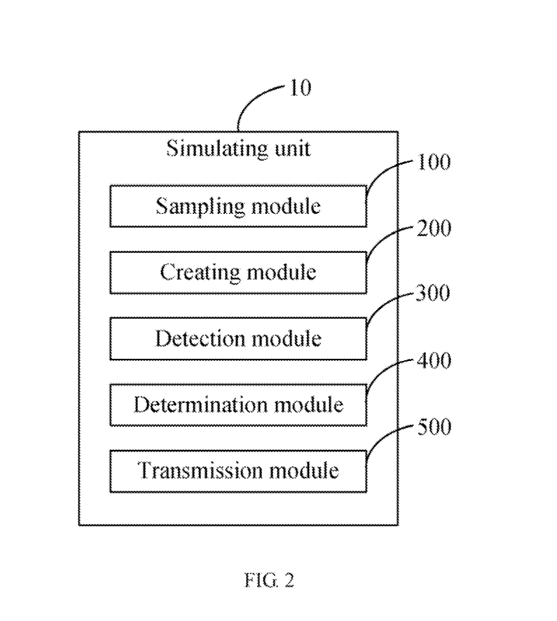

In one embodiment, the simulating unit 10 may include one or more function modules (a description is given in FIG. 2). The one or more function modules may comprise computerized code in the form of one or more programs that are stored in the storage unit 20, and executed by the processor 60 to provide the functions of the simulating unit 10. The storage unit 20 may be a cache or a dedicated memory, such as an EPROM or a flash memory.

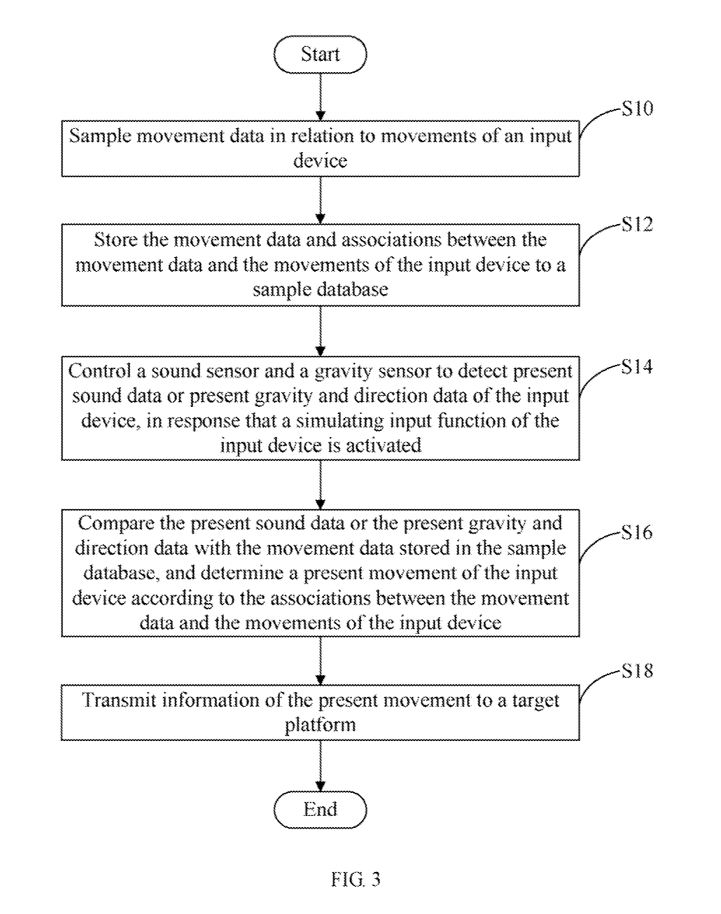

FIG. 2 is a block diagram of one embodiment of the function modules of the simulating unit 10. In one embodiment, the simulating unit 10 includes a sampling module 100, a creating module 200, a detection module 300, a determination module 400, and a transmission module 500. A detailed description of the functions of the modules 100-500 is shown in FIG. 3.

FIG. 3 is a flowchart of one embodiment of a method for simulating input using the input device 1. Depending on the embodiment, additional steps may be added, others removed, and the ordering of the steps may be changed.

In step S10, the sampling module 100 samples movement data in relation to movements of the input device 1. The movements of the input device 1 include upward movements, downward movements, and horizontal movements in two-dimensions or three-dimensions. In the embodiment, if the input device 1 moves downwards and touches a contact surface (e.g., the surface of a table), the sound sensor 30 detects sound data of the input device 1, the sound data as such, is about contact between the input device 1 and the contact surface. If the input device 1 moves upwards or moves horizontally, the gravity sensor 40 detects gravity and direction data of the input device 1. The movement data includes the sound data, the gravity data or the direction data mentioned above.

In step S12, the creating module 200 stores the movement data and associations between the movement data and the movements of the input device 1 to the sample database 50.

In step S14, the detection module 300 controls the sound sensor 30 and the gravity sensor 40 to detect present sound data or present gravity and direction data of the input device 1, in response that a simulating input function of the input device 1 is activated. In the embodiment, a user may push a button on the input device 1 or touch an application icon displayed on a screen of the input device 1 to activate the simulating input function.

In step S16, the determination module 400 compares the present sound data or the present gravity and direction data with the movement data stored in the sample database 50, and determines a present movement of the input device 1 according to the associations between the movement data and the movements of the input device 1.

In step S18, the transmission module 500 transmits information of the present movement to the target platform 2. The transforming module 70 of the target platform 2 transforms the received information of the present movement to a corresponding operation command, and outputs the corresponding operation on the screen 80 by executing the corresponding operation command Associations between the information of the present movements and the corresponding operation commands are preset according to a present input mode of the target platform 2. The input mode may include literal input, gesture input, and joystick input, for example.

In the embodiment, the movements of the input device 1 are similar to manipulating a mouse. For example, moving the input device 1 downwards and touching the contact surface can be interpreted as clicking a button of the mouse; moving the input device 1 horizontally on the contact surface can be interpreted as moving the mouse horizontally, which can simulate a literal input, a gesture input, or a joystick input; moving the input device 1 upwards and leaving the contact surface can be interpreted as releasing the button of the mouse.

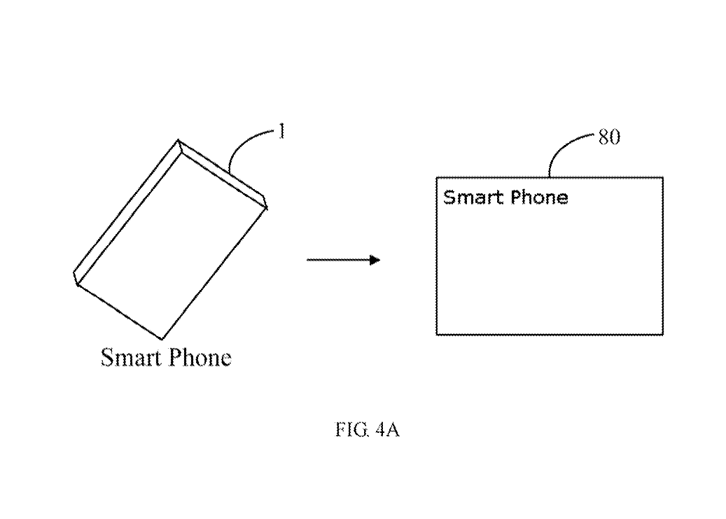

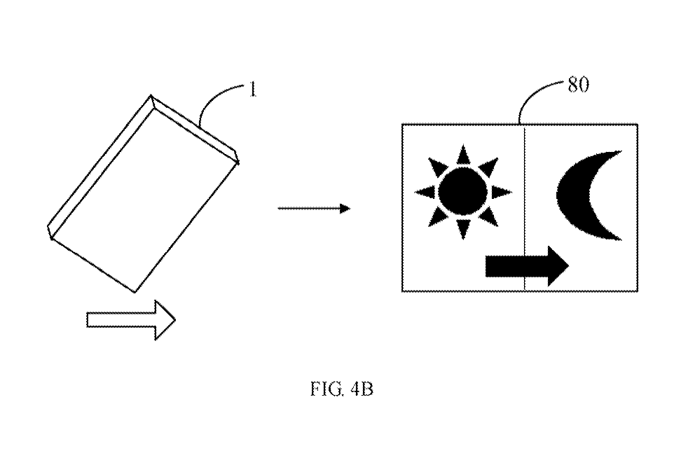

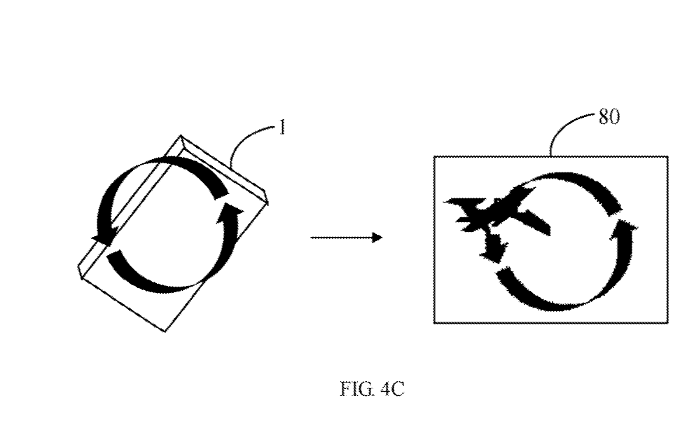

For example, in FIG. 4A, the user can write the words “Smart Phone” on the contact surface using the input device 1. The simulating unit 10 determines present movement of the input device 1 according to the sound data detected by the sound sensor 30 and the gravity and direction data detected by the gravity sensor 40, and transmits the information of the present movement to the target platform 2. The target platform 2 determines the present input mode is a literal input, and transforms the received information of the present movement to a corresponding literal input command, and outputs “Smart Phone” on the screen 80.

In FIG. 4B, the user moves the input device 1 rightwards on the contact surface. The simulating unit 10 determines the present movement of the input device 1 according to the gravity and direction data detected by the gravity sensor 40, and transmits the information of the present movement to the target platform 2. The target platform 2 determines the present input mode is a gesture input, and transforms the received information of the present movement to a corresponding gesture input command, and controls a picture displayed on the screen 80 to scroll rightwards or leftwards depending on the embodiment.

In FIG. 4C, the user tilts and swings the input device 1 counter-clockwise on the contact surface. The simulating unit 10 determines the present movement of the input device 1 according to the gravity and direction data detected by the gravity sensor 40, and transmits the information of the present movement to the target platform 2. The target platform 2 determines the present input mode is a joystick input, and transforms the received information of the present movement to a corresponding joystick input command, and controls a plane displayed on the screen 80 to move counter-clockwise or clockwise depending on the embodiment.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method of an input device, the method comprising:
(a) sampling movement data in relation to movements of the input device;
(b) storing the movement data and associations between the movement data and the movements of the input device in a sample database;
(c) determining a simulating input function of the input device according to a present movement of the input device according to the associations between the movement data and the movements of the input device from the sample database; and
(d) transmitting information of the present movement to a target platform.

2. The method as claimed in claim 1, wherein between step (b) and step (c), the method further comprises:
controlling a sound sensor or a gravity sensor of the input device to detect present sound data or present gravity and direction data of the input device, in response to activation of the simulating input function of the input device.

3. The method as claimed in claim 1, wherein the method further comprises:
transforming the received information of the present movement to a corresponding operation command by the target platform, and outputting the corresponding operation on a screen of the target platform by executing the corresponding operation command

4. The method as claimed in claim 1, wherein the movements of the input device comprise upward movements, downward movements, and horizontal movements in two-dimensions or three-dimensions.

5. The method as claimed in claim 1, wherein the movement data of the input device comprises a sound data, a gravity data or a direction data of the input device.

6. The method as claimed in claim 3, wherein associations between the information of the present movements and the corresponding operation commands are preset according to a present input mode of the target platform, and the input mode comprises a literal input, a gesture input, and a joystick input.

7. A non-transitory storage medium storing a set of instructions, the set of instructions capable of being executed by a processor of an input device, to perform a method comprising:
(a) sampling movement data in relation to movements of the input device;
(b) storing the movement data and associations between the movement data and the movements of the input device in a sample database;
(c) determining a simulating input function of the input device according to a present movement of the input device according to the associations between the movement data and the movements of the input device from the sample database; and
(d) transmitting information of the present movement to a target platform.

8. The non-transitory storage medium as claimed in claim 7, wherein between step (b) and step (c), the method further comprises:
controlling a sound sensor or a gravity sensor of the input device to detect present sound data or present gravity and direction data of the input device, in response to activation of the simulating input function of the input device.

9. The non-transitory storage medium as claimed in claim 7, wherein the method further comprising:
transforming the received information of the present movement to a corresponding operation command by the target platform, and outputting the corresponding operation on a screen of the target platform by executing the corresponding operation command

10. The non-transitory storage medium as claimed in claim 7, wherein the movements of the input device comprise upward movements, downward movements, and horizontal movements in two-dimensions or three-dimensions.

11. The non-transitory storage medium as claimed in claim 7, wherein the movement data of the input device comprises a sound data, a gravity data or a direction data of the input device.

12. The non-transitory storage medium as claimed in claim 9, wherein associations between the information of the present movements and the corresponding operation commands are preset according to a present input mode of the target platform, and the input mode comprises a literal input, a gesture input, and a joystick input.

13. An input device wirelessly connected to a target platform, the input device comprising:
a storage unit;
at least one processor;
one or more programs that are stored in the storage unit and are executed by the at least one processor, the one or more programs comprising:
a sampling module that samples movement data in relation to movements of the input device;
a creating module that stores the movement data and associations between the movement data and the movements of the input device in a sample database;
a determination module that determines a simulating input function of the input device according to a present movement of the input device according to the associations between the movement data and the movements of the input device from the sample database; and
a transmission module that transmits information of the present movement to the target platform.

14. The input device as claimed in claim 13, wherein the input device further comprises a sound sensor and a gravity sensor, and the one or more programs further comprises: a detection module that controls the sound sensor and the gravity sensor to detect present sound data or present gravity and direction data of the input device, in response to activation of the simulating input function of the input device.

15. The input device as claimed in claim 13, wherein the movements of the input device comprise upward movements, downward movements, and horizontal movements in two-dimensions or three-dimensions.

16. The input device as claimed in claim 13, wherein the movement data of the input device comprises a sound data, a gravity data or a direction data of the input device.
